(19) United States
(12) Patent Application Publication
(10) Pub. No.: US 2016/0107419 A1
(43) Pub. Date: Apr. 21, 2016

(54) METAL-AND-RESIN COMPOSITE AND METHOD FOR MAKING SAME

(71) Applicant: FIH (HONG KONG) LIMITED, Kowloon (HK)

(72) Inventors: CHWAN-HWA CHIANG, New Taipei (TW); CHIEH-HSIANG WANG, New Taipei (TW)

(21) Appl. No.: 14/589,566

(22) Filed: Jan. 5, 2015

(30) Foreign Application Priority Data
Oct. 15, 2014 (CN) 201410544865.4

(51) Int. Cl. B32B 15/08; B32B 15/09; B32B 15/082; B29C 45/14

(52) U.S. Cl. CPC B32B 15/08; B29C 45/14008; B32B 15/09; B32B 15/082; B29C 2045/14868; B29C 2045/14885; B29L 2009/005

(57) ABSTRACT

A metal-resin composite includes a metal member, a connecting layer formed on the metal member and a resin member. The connecting layer has a plurality of micro-pores and is made of inorganic material. The resin member is filled into the micro-pores and covered on a surface of the connecting layer to bond with the metal member.

### FIELD

The subject matter herein generally relates to a metal-and-resin composite and a method for making the metal-and-resin composite.

### BACKGROUND

Integrated metals and synthetic resins are used in a wide range of industrial fields including the production of parts for automobiles, domestic appliances, industrial machinery, and the like. Generally, the metal and the resin are joined together by adhesive. However, this method cannot supply a high-strength composite of metal and resin. There is a need to combine metal and resin together.

### BRIEF DESCRIPTION OF THE FIGURES

Implementations of the present technology will now be described, by way of example only, with reference to the attached figures.

FIG. 1 is a cross-sectional view of an exemplary embodiment of a metal-and-resin composite.

FIG. 2 is a flow chart of a method for making a metal-and-resin composite in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented. The term “comprising” when utilized, means “including, but not necessarily limited to”; it specifically indicates open-ended inclusion or membership in the so-described combination, group, series and the like.

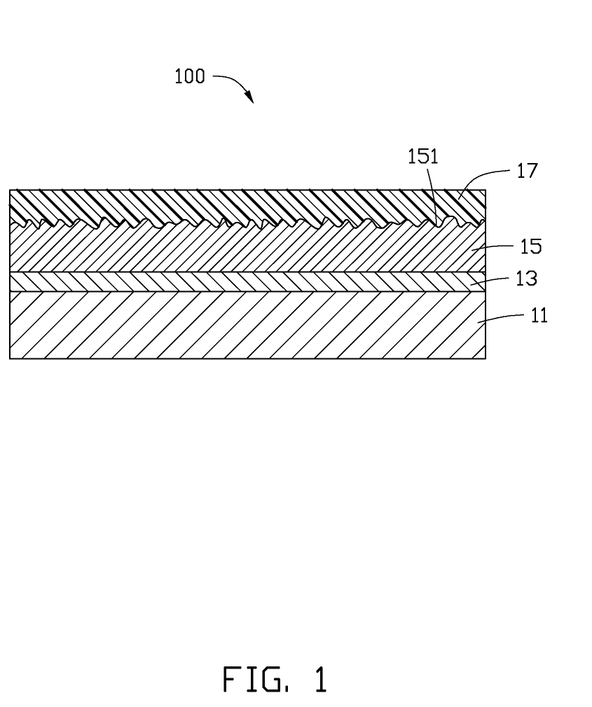

FIG. 1 illustrates a metal-and-resin composite 100 according to an exemplary embodiment. The composite 100 can include a metal member 11, an intermediate layer 13 formed on a surface of the metal member 11, a connecting layer 15 formed on the intermediate layer 13, and a resin member 17 formed on the connecting layer 15.

The metal member 11 can be selected from a group consisting of stainless steel, aluminum, aluminum alloy, zinc alloy, magnesium, magnesium alloy, copper and copper alloy.

The intermediate layer 13 and the connecting layer 15 can be formed by a spraying process. When fused inorganic material is sprayed onto a surface of the metal member 11, the surface of the metal member 11 can be partly melted, the melted metal member 11 and the fused inorganic material can penetrate each other to form the intermediate layer 13 having a thickness of about 0.1 μm to about 1 μm. The fused inorganic material can continue to be sprayed onto a surface of the intermediate layer 13 until forming the connecting layer 15 having a thickness of about 1 μm to about 100 μm.

The connecting layer 15 can have a plurality of micro-pores 151. The diameter of the micro-pores 151 can be less than 100 μm. In the embodiment, the diameter of the micro-pores 151 can be 5 μm to about 100 μm. The depth of the micro-pores 151 can be less than 100 μm. The surface roughness of the connecting layer 15 can be about 2.0 μm to about 5.0 μm.

The inorganic material can be inorganic material powder or inorganic material wire. The inorganic material can be selected from a group consisting of metal, metal alloy, metal carbide, metal oxide, resin and ceramic.

The inorganic material powder has a diameter of about 5 μm to about 200 μm and can be selected from a group consisting of self-fluxing powder, ceramic powder, carbide powder, abradable powder and metal alloy powder. In at least one exemplary embodiment, the inorganic material powder can be ceramic powder.

The self-fluxing powder can be nickel-based self-fluxing powder or cobalt-based self-fluxing powder.

The ceramic powder can be selected from a group consisting of aluminum oxide, chromium oxide, titanium oxide and zirconium oxide.

The carbide powder can be chromium carbide or wolfram carbide.

The abradable powder can be selected from a group consisting of aluminium powder, cobalt powder, copper powder, nickel powder, and resin powder.

The metal alloy powder can be selected from a group consisting of zinc alloy powder, Zn—Al alloy powder, aluminium alloy powder, copper alloy powder, iron alloy powder, molybdenum alloy powder, nickel alloy powder, titanium alloy powder, and cerament powder. The ceramic powder can be made of Cr₃C₂—NiCr or WC—Co.

The inorganic material wire has a diameter of about 1.0 mm to about 5.0 mm and can be selected from a group consisting of zinc wire, Zn—Al alloy wire, aluminium wire, tin wire, copper wire, stainless steel wire, albronze wire and molybdenum wire.

The resin member 17 can be filled into the micro-pores 151 and covered on the connecting layer 15. The metal member 11, the intermediate layer 13, the connecting layer 15, and the resin member 17 cooperatively form the composite 100. The micro-pores 151 formed on the connecting layer 15 can enhance bonding strength between the metal member 11 and the resin member 17.

The resin member 17 can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

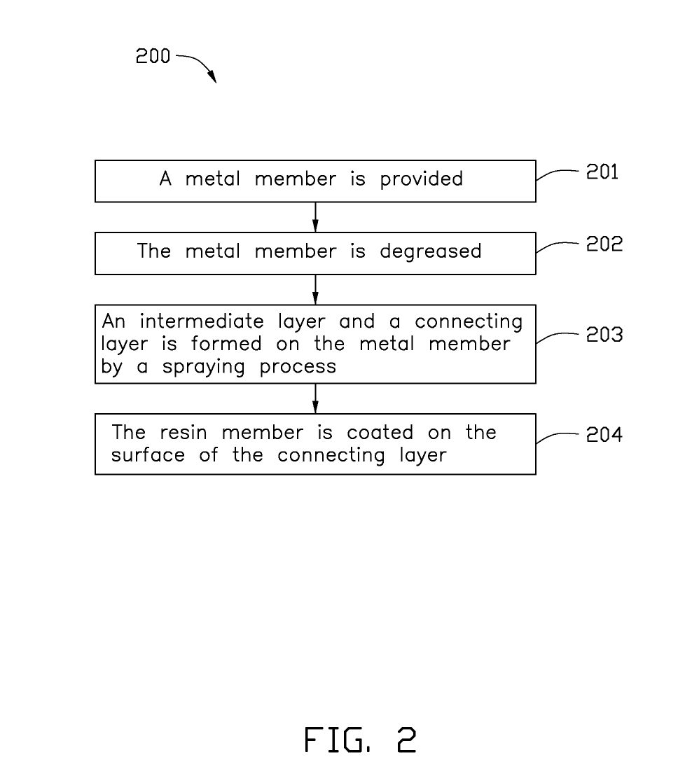

Referring to FIG. 2, a flowchart is presented in accordance with a first embodiment. The method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the example method 200. Furthermore, the illustrated order of blocks is illustrative only and the order of the blocks can change according to the present disclosure. Additional blocks may be added or fewer blocks may be utilized, without departing from this disclosure. The example method 200 can begin at block 201.

At block 201, a metal member 11 is provided. The metal member 11 can be made by casting, punching, or computer number control. The metal member 11 can be made of metal which can be selected from a group consisting of stainless steel, aluminum, aluminum alloy, magnesium, magnesium alloy, copper, copper alloy, and zinc alloy.

At block 202, the metal member 11 is degreased. The degreasing process may include a step of dipping the metal member 11 in a degreasing solution for about 1 minute to about 6 minutes. The degreasing solution may be a conventional degreasing solution having a concentration of about 90-150 g/L. The temperature of the degreasing solution may be about 20° C. to about 30° C. Then, the metal member 11 is removed from the degreasing solution and rinsed in water.

At block 203, the metal member 11 is covered with an intermediate layer 13 and a connecting layer 15 by blasting inorganic material on a surface of the metal member 11. The inorganic material can be inorganic material powder or inorganic material wire. The inorganic material can be selected from a group consisting of metal, metal alloy, metal carbide, metal oxide, resin and ceramic. The intermediate layer 13 and the connecting layer 15 can be formed by the following two methods:

In a first method, the intermediate layer 13 and the connecting layer 15 can be formed by a plasma spraying process, the plasma spraying process can be carried out by blasting inorganic material powder from a spray gun (not shown) of a plasma spraying device (not shown) onto a surface of the metal member 11, and a spraying distance between the spray gun and the metal member 11 can be about 50 mm to about 800 mm. A voltage of the plasma spraying device can be about 220V to about 275 V, an electric current of the plasma spraying device can be about 378 A to about 600 A. Working gas having a flow speed of about 45 m/min to about 120 m/min can be inlet into the plasma spraying device, the working gas can generate a plasma arc having a temperature of about 1000° C. to about 12000° C. in the effect of the electric current. The working gas can be selected from a group consisting of N₂ and H₂, Ar and H₂, or Ar. The organic material powder can be led into the plasma spraying device at a speed of about less than 150 g/min, and the organic material powder can be heated to a molten state, and molten organic material powder can be sprayed on to the surface of the metal member 11 at a speed of about 430 m/s to about 527 m/s by a feeding gas, such as N₂. The feeding gas has a flow speed of about 14 L/min to about 18 L/min, and the pressure of the feeding gas can be about 1.0 Mpa to about 1.5 Mpa. A spraying angle between the axis of the path of the molten organic material powder sprayed out of the plasma device and the metal member 11 can be from about 45° to about 90°.

When the molten inorganic material is sprayed onto the surface of the metal member 11, the metal member 11 is partly melted, and the molten inorganic material and the melted metal member can penetrate to each other to form the intermediate layer 13 having a thickness of about 0.1 μm to about 1 μm.

The molten inorganic material can continue to be sprayed on a surface of the intermediate layer 13, such that a connecting layer 15 having a thickness of about 1 μm to about 100 μm can be formed on the intermediate layer 13. The connecting layer 15 can have a plurality of micro-pores 151, and the surface roughness of the connecting layer 15 can be about 2 μm to about 5 μm. The diameter of the micro-pores 151 can be less than 100 μm, in the embodiment, the diameter of the micro-pores 151 can be about 5 μm to about 100 μm. The average depth of the micro-pores 151 can be less than about 100 μm.

The spraying time can be changed according to the superficial area of the metal member 11 and the thickness of the connecting layer 15.

In a second method, an intermediate layer 13 and a connecting layer 15 can be formed by a flame spraying process, the flame spraying process can be carried out by blasting inorganic material wire from a spray gun (not shown) of a flame spraying device (not shown) onto the metal member 11, and a spraying distance between the spray gun and the metal member 11 can be about 50 mm to about 800 mm. Working gas can be inlet into the flame spraying device and burned to form a flame kernel having a temperature of about 1500° C. to about 2500° C. The working gas may comprise O₂ having a pressure of about 0.2 MPa to about 0.5 MPa and a combustible gas having a pressure of about 0.04 MPa to about 0.1 MPa, the combustible gas can be C₂H₂, H₂, or C₃H₈. During the burning process, a burning rate of O₂ can be about 1.6 m³/h to about 1.8 m³/h, a burning rate of the combustible gas can be about 0.5 m³/h to about 0.7 m³/h. The organic material wire can continue to be led into the flame kernel of the flame plasma device by an electro-motor (not shown), such that an end of the organic material wire can be heated to a molten state, and the drafting force of the electro-motor can be more than 10 Kg. The molten organic material wire can be atomized to form a plurality of fine particles by compressed air having a flowing speed of about 14 L/min to about 18 L/min, and fine particles can be sprayed out of the flame plasma device and covered on the metal member 11. A spraying angle between the axis of the path of the fine particles (not shown) sprayed out of the plasma device and the metal member 11 can be from about 45° to about 90°. The fine particles are derived from inorganic material wire.

When the fine particles are sprayed onto the surface of the metal member 11, the metal member 11 can be partly melted. The fine particles and the melted metal member 11 can penetrate to each other to form the intermediate layer 13 having a thickness of about 0.1 μm to about 1 μm.

The fine particles can continue to be sprayed on a surface of the intermediate layer 13, such that a connecting layer 15 having a thickness of about 1 μm to about 100 μm can be formed on the intermediate layer 13. The connecting layer 15 can comprise a plurality of micro-pores 151, and the surface roughness of the connecting layer 15 can be about 2 μm to about 5 μm. The diameter of the micro-pores 151 can be less than 100 μm. In the embodiment, the diameter of the micro-pores 151 can be about 5 μm to about 100 μm. The average depth of the micro-pores 151 can be less than about 100 μm.

The spraying time can be changed according to the superficial area of the metal member 11 and the thickness of the connecting layer 15.

At block 704 the metal member 11 having the connecting layer 15 can be put into a mold (not shown), the metal member 11 can be heated to a temperature of about 100° C. to about 500° C., and liquid resin can be filled into the micro-pores 151 and cover a surface of the connecting layer 15, forming the resin member 17. The metal member 11, the intermediate layer 13, the connecting layer 15, and the resin member 17 cooperatively form the composite 100. The micro-pores 151 formed on the connecting layer 15 can enhance bonding strength between the metal member 11 and the resin member 17. The thickness of the resin member 17 can be changed according to the need of the composite 100.

The resin can be selected from a group consisting of polybutylene terephthalate (PBT), polyphenylene sulfide (PPS), polyethylene terephthalate (PET), polyether ether ketone (PEEK), polycarbonate (PC) and polyvinyl chloride polymer (PVC).

Tensile and shear strength tests were applied to the composite 100. The results show that the tensile strength of the composite 100 can reach 2-15 MPa, and the shear strength of the composite can reach 6-30 MPa. After repeated cold and hot shock testing for 48 hours at temperatures in a range of −40° C. to 85° C., in 4 hour cycles, the tensile and shear strength of the composite 100 do not become notably weaker.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A metal-resin composite comprising:
a metal member;
a connecting layer formed on the metal member, the connecting layer defining a plurality of micro-pores and comprising an inorganic material; and
a resin member being filled into the micro-pores and covered on a surface of the connecting layer to bond with the metal member.

2. The metal-resin composite as claimed in claim 1, wherein the connecting layer has a thickness of about 1 μm to about 100 μm, and a surface roughness of about 2.0 μm to about 5.0 μm.

3. The metal-resin composite as claimed in claim 1, wherein each micro-pore has a diameter of about 5 μm to about 100 μm, and a depth of about less than 100 μm.

4. The metal-resin composite as claimed in claim 1, wherein the metal-resin composite further includes an intermediate layer formed on a surface of the metal member, the intermediate layer is made of inorganic material, the connecting layer is formed on the intermediate layer.

5. The metal-resin composite as claimed in claim 4, wherein the intermediate layer has a thickness of about 0.1 μm to about 1 μm.

6. The metal-resin composite as claimed in claim 4, wherein the inorganic material is inorganic material powder having a diameter of about 5 μm to about 100 μm or inorganic material wire having a diameter of about 1 μm to about 5 μm, and the inorganic material is selected from a group consisting of metal, metal alloy, metal carbide, metal oxide, resin and ceramic.

7. The metal-resin composite as claimed in claim 6, wherein the inorganic material powder is selected from a group consisting of self-fluxing powder, ceramic powder, carbide powder, abradable powder and metal alloy powder.

8. The metal-resin composite as claimed in claim 7, wherein the self-fluxing powder is nickel-based self-fluxing powder or cobalt-based self-fluxing powder; the ceramic powder is selected from a group consisting of aluminum oxide, chromium oxide, titanium oxide and zirconium oxide; the carbide powder is chromium carbide or wolfram carbide;
the abradable powder is selected from a group consisting of aluminium powder, cobalt powder, copper powder, nickel powder, and resin powder; the metal alloy powder is selected from a group consisting of zinc alloy powder, Zn—Al alloy powder, aluminium alloy powder, copper alloy powder, iron alloy powder, molybdenum alloy powder, nickel alloy powder, titanium alloy powder, and cerament powder.

9. The metal-resin composite as claimed in claim 7, wherein the cerament powder is made of Cr₃C₂—NiCr or WC—Co.

10. The metal-resin composite as claimed in claim 6, wherein the inorganic material wire is selected from a group consisting of zinc wire, Zn—Al alloy wire, aluminium wire, tin wire, copper wire, stainless steel wire, albronze wire and molybdenum wire.

11. The metal-resin composite as claimed in claim 1, wherein the resin member is selected from a group consisting of polybutylene terephthalate, polyphenylene sulfide, polyethylene terephthalate, polyether ether ketone polycarbonate and polyvinyl chloride polymer.

12. A method for making a metal-resin composite, comprising:
providing a metal member;
blasting the metal member with inorganic material to form a connecting layer on the metal member, the connecting layer having a plurality of micro-pores;
inserting the metal member into a mold; and
injecting molten resin on the metal member, the resin being filled into the micro-pores and covered on a surface of the connecting layer to form a resin member bonded with the metal member.

13. The method for making a metal-resin composite as claimed in claim 12, wherein the method for making the metal-resin composite further includes a step of blasting the metal member with inorganic material to form an intermediate layer on a surface of the metal member, the connecting layer is formed on the intermediate layer.

14. The method for making a metal-resin composite as claimed in claim 13, wherein the intermediate layer is formed by a plasma spraying process, the plasma spraying process is carried out by blasting molten inorganic material powder from a spray gun of a plasma spraying device onto the metal member.

15. The method for making a metal-resin composite as claimed in claim 14, wherein the molten organic material powder are sprayed onto the surface of the metal member, the metal member is partly melted, the molten organic material powder and the melted metal member penetrate to each other to form the intermediate layer having a thickness of about 0.1 μm to about 1 μm, the molten organic material powder continues to be sprayed onto a surface of the intermediate layer to form the connecting layer.

16. The method for making a metal-resin composite as claimed in claim 14, wherein the connecting layer has a thickness of about 1 μm to about 100 μm, and a surface roughness of about 2 μm to about 5 μm.

17. The method for making a metal-resin composite as claimed in claim 13, wherein the intermediate layer is formed by a flame spraying process, the flame spraying process is carried out by blasting fine particles derived from inorganic material wire from a spray gun of a flame spraying device onto the metal member.

18. The method for making a metal-resin composite as claimed in claim 17, wherein the fine particles are sprayed onto a surface of the metal member, the metal member is partly melted, the fine particles and the melted metal member penetrate to each other to form the intermediate layer having a thickness of about 0.1 μm to about 1 μm, the fine particles continue to be sprayed onto a surface of the intermediate layer to form the connecting layer having a thickness of about 1 μm to about 100 μm.

19. The method for making a metal-resin composite as claimed in claim 12, wherein each micro-pore has a diameter of about 5 μm to about 100 μm, and an average depth of about is less than 100 μm.
